(19) United States
(12) Patent Application Publication
(10) Pub. No.: US 2025/0363570 A1
(43) Pub. Date: Nov. 27, 2025

(54) SYSTEM AND METHOD FOR MANAGING A WAREHOUSE ON A FARM

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,181

(22) Filed: Aug. 7, 2025

Related U.S. Application Data
(63) Continuation of application No. PCT/IB2023/061305, filed on Nov. 9, 2023.

(30) Foreign Application Priority Data
Feb. 9, 2023 (DE) 10 2023 103 208.9

(51) Int. Cl. G06Q 50/02; G06Q 10/087

(52) U.S. Cl. CPC G06Q 50/02; G06Q 10/08726

(57) ABSTRACT

A system and method for managing a warehouse on a farm. The system comprises a server, a database, and at least one user end device. A module for managing the warehouse and information and/or criteria for managing the warehouse is stored in the database. The module is executable by the at least one user end device and the server is hosting the module for the at least one user end device. Upon execution of the module by the at least one user end device, the module is configured to manage a stock of spare parts in the warehouse based on the information and/or criteria stored in the database.

### CROSS REFERENCE TO RELATED APPLICATIONS

This application is a continuation-in-part and claims priority to PCT Application No. PCT/IB2023/061305 (published as WO/2024/165905) filed on Nov. 9, 2023, which claims priority to German Patent Application No. 10 2023 103 208.9 filed Feb. 9, 2023, the entire disclosure of both which are hereby incorporated by reference herein. This application is also related to U.S. application Ser. No. ______ (attorney docket no. 15191-24025A (P05768/8)), U.S. application Ser. No. ______ (attorney docket no. 15191-24026A (P05769/8)), U.S. application Ser. No. ______(attorney docket no. 15191-24027A (P05770/8)), U.S. application Ser. No. ______ (attorney docket no. 15191-24029A (P05772/8)), U.S. application Ser. No. ______ (attorney docket no. 15191-24030A (P05773/8)), U.S. application Ser. No. ______ (attorney docket no. 15191-24031A (P05774/8)), and U.S. application Ser. No. ______ (attorney docket no. 15191-24032A (P05775/8)), each of which are incorporated by reference herein in their entirety.

### TECHNICAL FIELD

The present invention relates to a system for managing a warehouse on a farm and a method for managing a warehouse on a farm.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Spare parts may be stored in central warehouses of manufacturers, local warehouses of service providers, spare part dealers and/or repair shops spread across a country or region in order to provide spare parts for maintenance and/or repair in the event of a failure of a vehicle.

An essential aspect for operating warehouses is the management of the warehouses, respectively the management of the stock. Spare parts frequently leave the warehouses, requiring the warehouses to be restocked. One solution is to have systems that automatically track a stock level of a warehouse and place an order for restocking the warehouse if a need is identified. For example, WO 2018/187788 A1 discloses a method for tracking a stock level within a store. The method includes, at a robotic system, navigating along a first inventory structure in the store, broadcasting radio frequency interrogation signals according to a first set of wireless scan parameters, and recording a first set of wireless identification signals returned by radio frequency identification tags coupled to product units arranged on the first inventory structure, generating a first list of product units arranged on the first inventory structure based on the first set of wireless identification signals, detecting a first product quantity difference between the first list of product units and a first target stock list assigned to the first inventory structure by a planogram of the store and generating a stock correction prompt for the first inventory structure in response to the first product quantity difference.

Generally, the location of warehouses, either central warehouses or local warehouses, across the country is chosen in such a way that a connection to existing logistics networks for part distribution is possible. For central warehouses, often a location is chosen which ensures that part distribution to different local warehouses is possible with the least possible expenditure of time and resources. When one or more local warehouses run out of parts, it is therefore possible to restock the local warehouses according to their defined target stock as soon as possible. Part distribution networks comprising one or more central warehouses and many local warehouses distributed across the country being connected to existing logistics networks also may guarantee a supply of parts when one local warehouse runs out of stock.

### BRIEF DESCRIPTION OF THE DRAWING

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example system for managing a warehouse on a farm in which spare parts for one or more agricultural machines of a fleet of agricultural machines are stocked.

### DETAILED DESCRIPTION

As discussed in the background, spare parts may be stored in a variety of places as a part distribution network. However, there are countries or regions where establishing such parts distribution networks is impossible due to a lack of infrastructure and logistics. This is especially a problem in the field of agriculture. Areas that are cultivated are normally located in regions with only little or no infrastructure and logistics. For example, in countries like the United States, there are regions almost completely formed by fields and farms cultivating lots of hectares of farmland. When it comes to maintenance service availability and/or spare part availability for agricultural machines there is often the problem that only few service providers, spare part dealers and/or dealer ships of manufacturers are located in these regions, with distances of hundreds of kilometers in between these facilities and the farms. To address these challenges, some manufacturers of spare parts and/or agricultural machines sell warehouses to their customers for stocking spare parts directly on the farm. The customer is able to perform maintenance work and/or repair work directly on the farm having spare parts for those parts of the agricultural machines that are generally subject to severe wear or failure during operation.

Stocking and replenishing of these warehouses are typically done by manual operation. The user of the warehouse calls the service provider, spare part dealer or manufacturer and places an order for the spare parts that will most likely suffer from severe wear or failure during the harvest season/campaign. The service provider, spare part dealer or manufacturer instructs and triggers the order placed so that the spare parts required will be procured and delivered to the warehouse. Often, significant time passes between placing the order and the arrival of the spare parts on the farm. However, when it comes to a failure of a part, especially during the harvest season/campaign, the farmer has a high interest in the delivery of the part as quickly as possible as machine downtime immediately results in significant economic losses. Complicating matters further is when the warehouse is located at or on or proximate to (e.g., less than ½ mile, less than 1 mile, etc.) from the farm. As one example, replenishing the spare part(s) of the warehouse on the farm may comprise sending (such as automatically sending via drones or self-driving vehicles) spare part(s) from a manufacturer directly to the warehouse on the farm and/or sending (such as automatically sending via drones or self-driving vehicles) spare part(s) from another warehouse (such as a central warehouse or storage facility, a neighboring warehouse farm, etc.) to the warehouse on the farm. As discussed further below, the system may automatically determine: how much to stock of the spare part(s) at the warehouse on the farm; the timing of when to stock the spare part(s) at the warehouse on the farm; and the transport (such as automatic transport) of the spare part(s) to the warehouse on the farm in order reconcile when and how many spare parts are needed on the farm. In this regard, managing the warehouse on the farm adds a layer of complexity not found when managing a centrally located warehouse.

To avoid such losses, the user often pre-orders many spare parts for parts which might suffer from severe wear or a failure during the harvest campaign/season. After the harvest season/campaign, however, the user regularly finds that not all spare parts pre-ordered have been used. These spare parts usually cannot be sent back to the service provider, spare part dealer or manufacturer; in addition, some of these spare parts cannot be used in the next harvest season/campaign due to an expiry date.

Therefore, it is an object of the present invention to overcome one or more shortcomings, such as those mentioned above. In particular, in one or some embodiments, a system and method are disclosed that enable an easy and efficient management of a warehouse on a farm with a focus on serving the needs of a user of the warehouse on the respective farm.

Thus, in one or some embodiments, a system configured to manage a warehouse on a farm is disclosed in which spare parts for at least one agricultural machine of a fleet of agricultural machines are stocked. The system comprises a server, a database, and at least one user end device (e.g., a computer, tablet, smartphone or the like). The server, the database, and the at least one user end device may be communicatively connected to each other via one or more networks (e.g., via a wired and/or wireless network). At least one module (e.g., a computer-executable module) configured to manage the warehouse and information and/or criteria for managing the warehouse may be stored in the database. The module may be executable by the at least one user end device, with the server is hosting the module for the at least one user end device. Upon execution of the module by the at least one user end device, the module may be configured to manage a stock of spare parts in the warehouse based on the information and/or criteria stored in the database. For example, the management of the stock may comprise automatic performing any one, any combination, or all of: automatically determining current stock in one or more warehouses and/or service vehicles; automatically determining current or future needs for stock of spare parts; automatically determining timing of the needs for stock of spare parts; automatically ordering the spare parts; or automatically transporting the spare parts (e.g., via drones or autonomous vehicles to and/or from the warehouses and/or service vehicles; via robots within the warehouse and/or into or out of the warehouse).

The system may provide a holistic approach to manage a warehouse filled with different spare parts for one or more agricultural machines, especially in countries or regions having little or no logistics infrastructure to supply customers of agricultural machines with spare parts to secure operation of these machines. The module for managing the warehouse thereby may define an interface (e.g., a graphical user interface (GUI)) for accessing and processing the different information and/or criteria under the premise of automatically coordinating and/or automatically advising all players of the global ecosystem involved in the operation of the warehouse and/or automatically transporting in and/or out of the warehouse (e.g., via drones, robots and/or self-driving vehicles). The system may guarantee an easy and efficient management of the warehouse with a focus on serving the needs of the user, even if procurement of spare parts is a challenge due to missing logistics infrastructure. All players of the global ecosystem may influence the managing process via user end devices configured to execute the module and, in turn, automatically initiate processing according to the functional scope of the module.

In one or some embodiments, the module is configured to automatically determine a stock of spare parts recommended to be stocked in the warehouse to secure operation of the at least one agricultural machine during a predetermined time period, such as a harvest season or an entire calendar year.

Determining a stock of spare parts, which may be necessary for securing operation of different agricultural machines, is often not easy for the user. This may be especially true when it comes to quite inexperienced users operating the fleet of agricultural machines, which is a challenge for these users to determine which spare parts to stock in order to be able to service or repair the machines in case of a failure during the harvest season/campaign due to a variety of available information. By having a function to automatically recommend a stock/package of spare parts, the module may relieve the users from this challenge. In turn, the recommended stock/package may be automatically implemented, such as via drones and/or self-driving vehicles. As the module is, in principle, able to automatically access and automatically consider an unlimited amount of information and/or criteria for performing managing functions, the configuration of a stock/package of spare parts may be more efficient under the premise of serving the needs of the user.

In one or some embodiments, the module is configured to determine the stock of spare parts automatically recommended to be stocked in the warehouse according to the objective that the spare parts have been used after the expiry of the time period.

By automatically determining spare part packages to be stocked in the warehouse, not only the need of the user from the perspective of securing operation of the agricultural machines, but also from the economic perspective of keeping the business running with the lowest possible investments may be served.

In one or some embodiments, the module is configured to automatically instruct and automatically trigger an ordering of spare parts for the warehouse and/or automatically implement the transport (e.g., via drones, automated self-driving vehicles or the like), a stocking of the warehouse with spare parts and/or a replenishment of the warehouse with spare parts, such as according to the recommended stock of spare parts determined. In turn, the automatic ordering may trigger an automatic (or at least partly automatic) delivery of the spare parts (e.g., any one, any combination, or all of: automatic robots transferring the spare part into a respective warehouse; automatic robots transferring the spare part within the respective warehouse (such as automatically moving, via a robot, the spare part from a stocked shelf to the loading dock of the warehouse and/or into a vehicle for transport); automatic shipping using automatic driving trucks, automatic shipping by automatic drone, etc.).

This function of the module may relieve the user from further time-consuming tasks in managing the stock of the warehouse. In particular, the warehouse may be stocked, such as always stocked, according to the needs and specifications of the user. Especially for spare parts that comprise only a limited lifetime, this functional scope may be beneficial. If such spare parts stocked in the warehouse are used to service or to repair the agricultural machines, replenishment of these spare parts may be initiated in real-time, such as immediately.

In one or some embodiments, the at least one user end device and/or the warehouse may comprise a sensor arrangement for automatic identification of spare parts being placed in the warehouse and/or automatically being dispatched out of the warehouse. In this regard, the system may dynamically and automatically update the determination as to the stock of a respective part within the warehouse.

In one or some embodiments, the module is configured to automatically track receipt of spare parts in the warehouse and/or automatically track dispatch of spare parts out of the warehouse based on the automatically-identified spare parts.

In one or some embodiments, the spare parts comprise identification tags which are automatically readable by the sensor arrangement and/or the sensor arrangement is configured to automatically identify the spare parts using image recognition.

In one or some embodiments, the module is configured to automatically link the spare parts being placed in the warehouse and/or being dispatched out of the warehouse with the at least one agricultural machine.

The ability to track receipt and/or dispatch of spare parts using sensor arrangements may significantly improve the managing of the warehouse. In more detail, the user of the warehouse may be further relieved by the module from planning, coordinating and supervising a stocking of the warehouse. Rather, the module may enable a stocking of the warehouse that is essentially autonomous, meaning without any or with a reduced or least involvement of the user. In case spare parts are dispatched out of the warehouse, the module may be able to immediately and automatically instruct and trigger a replenishment of the warehouse with the spare parts dispatched (e.g., automatically trigger an order for the respective spare part and/or automatically transport the respective spare part via drone or autonomous vehicle). By automatically identifying the receipt of the replenished spare part, the module is aware of the procurement process being completed successfully. The linking of spare parts with specific agricultural machines may provide the module with the ability to automatically associate and automatically track spare part-consumption with the unique agricultural machine.

In one or some embodiments, the information and/or criteria for managing the warehouse on the farm may be related to any one, any combination, or all of: the warehouse on the farm itself; the at least one agricultural machine; at least one central storage for spare parts; at least one neighboring warehouse for spare parts on a neighboring farm; part runners; or drones for automatic transportation of spare parts between different facilities and/or entities.

In one or some embodiments, any one, any combination, or all of the warehouse, the at least one agricultural machine on the farm, the at least one central storage, the at least one neighboring warehouse, the part runners or the drones may communicate (e.g., wired and/or wirelessly) with one another, and may communicate (e.g., wired and/or wirelessly) with any one, any combination, or all of the server, the database, or the at least one user end device via the network to provide the respective information and/or criteria for managing the warehouse to the database for storing the same.

In one or some embodiments, the information and/or criteria for managing the warehouse may comprise any one, any combination, or all of the following: information regarding a geographic position and/or an actual stock of the warehouse; criteria regarding the stock of the warehouse; information regarding a configuration of the at least one agricultural machine; information regarding an operation of the at least one agricultural machine; information regarding crops harvested by the at least one agricultural machine; information regarding agronomic conditions at the geographical position of the warehouse; information regarding climatic conditions at the geographical position of the warehouse; information regarding a geographical position and/or an actual stock of the at least one central storage; information regarding a geographical position and/or an actual stock of the at least one neighboring warehouse; or information regarding a geographical position, an availability and/or a capacity of the part runners and/or the drones.

In one or some embodiments, the module is configured to automatically generate a geographical map for output on a display and containing at least some of the information and/or criteria for managing the warehouse on the respective farm, such as containing stock information of the warehouse on the respective farm, the at least one central storage and/or the at least one neighboring farm. In this regard, a user may interact with the geographical map (e.g., tap on parts of the geographical map) for accessing the information and/or criteria contained within the geographic map. In one particular example, the map may have embedded therein image or textual information indicative of the stock information of the warehouse on the respective farm and/or stock information at the at least one central storage and/or stock information at the at least one neighboring farm.

In one or some embodiments, at least some of the information and/or criteria for managing the warehouse on the farm is definable by any one, any combination, or all of a user of the warehouse on the farm, a service provider, a spare part dealer, manufacturer of spare parts, or the at least one agricultural machine used on the farm. In one or some embodiments, defining the information and/or criteria may be performed via the at least one user end device.

Consideration of different information and/or criteria related to the different players of the global ecosystem for operating the warehouse on the farm may increase the accuracy and efficiency in managing the warehouse. Moreover, consideration of a set of information and/or criteria may enable the module to perform at least some of the functions for managing the warehouse on the farm essentially autonomously, meaning without any or with a reduced or a least-possible involvement of the user.

In one or some embodiments, the at least one user end device is configured to interact with the module via an application configured to execute on the at least one user end device.

Provision of an application running on the user end devices, such as for example smartphones, tablets, personal computer or the like, may provide a particularly easy way of interacting between the facilities and/or entities, such as the user of the warehouse on the farm, service providers, spare part dealers, manufacturers of spare parts and/or agricultural machines used on the farm or the like, and the module may thus improve the result of the management process.

In one or some embodiments, the module is assigned to an entity which is independent of a user of the warehouse on the farm, wherein access to use the module by the user of the warehouse on the farm is enabled by the entity if an authorization is present.

Providing a user of the warehouse on the farm with access to use the module and, thus, the functions to manage the warehouse on the farm, only if an authorization is present, may enable offering the module as a service by the entity. Therefore, the module does not only provide economic benefits to the user of the warehouse on the farm, but also to the entity offering the module, such as for example a service provider or a manufacturer of spare parts and/or agricultural machines on or used by the respective farm.

Further, in one or some embodiments, a method is disclosed for managing a warehouse on a farm in which spare parts for at least one agricultural machine of a fleet are stocked using a system. The system may comprise a server, a database, and at least one user end device, wherein the server, the database, and the at least one user end device communicate (e.g., wired and/or wirelessly) with each other via one or more networks. A module for managing the warehouse and information and/or criteria for managing the warehouse are stored in the database, wherein the module may be executable by the at least one user end device. The server may host the module for the at least one user end device. Upon execution of the module by the at least one user end device, a stock of spare parts in the warehouse is automatically managed based on the information and/or criteria stored in the database. The features defined herein with regard to the system are equally applicable to the method.

Thus, in one or some embodiments, to ensure that the spare parts are also available, the system may automatically plan and automatically coordinate the management of the spare parts, including automatically assembling the parts stock stored in the respective warehouses in respective farms in such a way to solve the problems that predominantly arise in a respective region, either by already having the requisite spare parts in stock and/or by automatically organizing their procurement from central warehouses. In one or some embodiments, the system may automatically factor region-specific requirements, such as the cultivation of wear-intensive grain/crop types, when is the harvest, etc. in automatically managing the procurement, storage and/or transportation of the spare parts.

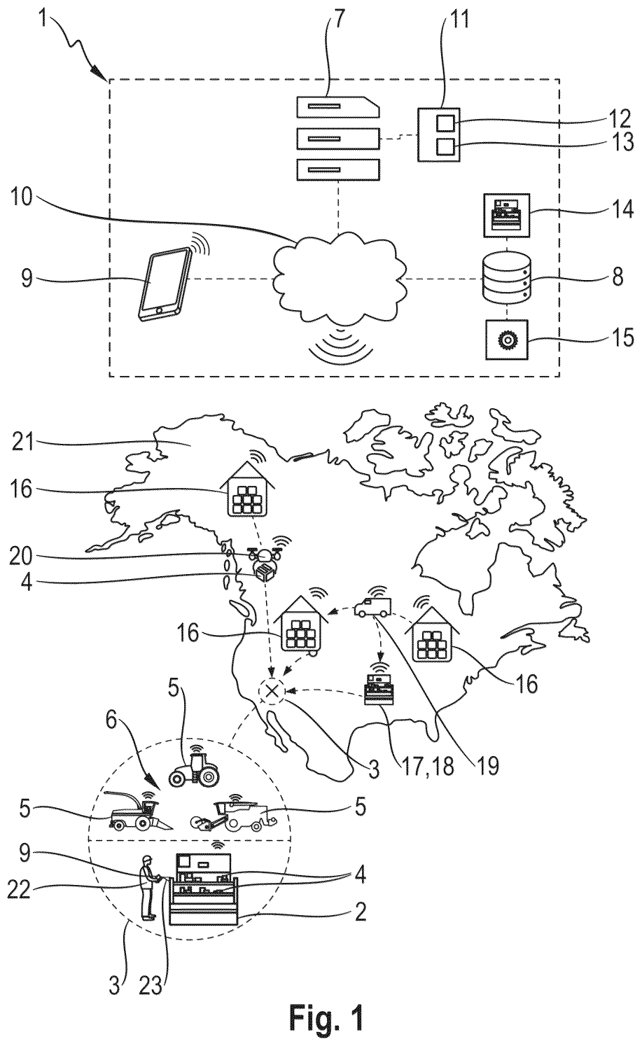

Referring to the FIGURE, FIG. 1 illustrates a system 1 for managing a warehouse 2 on a farm 3 in which spare parts 4 for one or more agricultural machines 5 of a fleet 6 of agricultural machines 5 are stocked. The fleet 6 of agricultural machines 5 may comprise one or more tractors, one or more forage harvesters, one or more combine harvesters, one or more agricultural balers or the like.

The system 1 comprises a server 7, a database 8 and one or more user end devices 9 which may be configured as smartphones, tablets, personal computers or the like. The server 7, the database 8 and the one or more user end devices 9 may be in communication (e.g., wired and/or wirelessly) with each other via a network 10. Thus, the network 10 may enable an exchange of information and data between the different devices 7, 8, 9.

The server 7 may comprise a processing device 11 which may enable processing of the data and information exchanged between the server 7, the database 8 and/or the one or more user end devices 9. The processing device 11 may comprise any type of computing functionality, such as at least one processor 12 (which may comprise a microprocessor, controller, PLA, or the like) and at least one memory 13. The memory 13 may comprise any type of storage device (e.g., any type of memory). Though the processor 12 and the memory 13 are depicted as separate elements, they may be part of a single machine, which includes a microprocessor (or other type of controller) and a memory. Alternatively, the processor 12 may rely on memory 13 for all of its memory needs.

The processor 12 and memory 13 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the processing device 11 which may comprise the at least one processor 12 and the at least one memory 13 may be applied to other devices, such as the user end devices 9 mentioned above.

A module 14 for managing the warehouse 2 on the farm 3 may be stored in the database 8 and configured to be executed by the one or more user end devices 9. The server 7 may host the module 14 for the one or more user end devices 9. In one or some embodiments, upon execution of the module 14 by the one or more user end devices 9, the module 14 is configured to automatically manage a stock of spare parts in the warehouse 2. Execution of and interaction with the module 14 by the one or more user end devices 9 may be possible via an application which may be configured to run on the one or more user end devices 9. For automatically managing the stock of the warehouse 2, the module 14 may use computational resources provided by internal processing devices (e.g., at least one processor) of the one or more user end devices 9 and/or computational resources provided by the processing device 11. To automatically manage the stock of spare parts 4 in the warehouse 2, the module 14 is configured to automatically access specific data. Such data may comprise information and/or criteria 15 for automatically managing the warehouse 2 on the farm 3, the information and/or criteria 15 being stored in the database 8. To enable the module 14 to automatically manage the warehouse 2, the information and/or criteria 15 may be processed by the one or more internal processing devices of the one or more user end devices 9 and/or the processing device 11. The processing devices may use different methods or algorithms for automatically processing the information and/or criteria 15. Some or all of these methods or algorithms may be based on artificial intelligence (AI). In one or some embodiments, the processing is based on recourses provided by a neural network.

To automatically manage the warehouse 2 efficiently and accurately, it may be necessary to consider information from the entire ecosystem of the warehouse 2, such as the different facilities and/or entities involved in an operation cycle of the warehouse 2. Therefore, the information and/or criteria 15 for managing the warehouse 2 may be related to any one, any combination, or all of the warehouse 2, the one or more agricultural machines 5 of the fleet 6, one or more central storages 16 for spare parts 4, one or more neighboring warehouses 17 for storing spare parts 4 on neighboring farms 18, part runners 19 (e.g., automated self-driving vehicles) for transporting spare parts 4 between different facilities and/or entities, and/or drones 20 for automatically transporting spare parts 4 between different facilities and/or entities. Thus, part runners 19 may be vehicles guided by drivers between the different facilities and/or entities to transport spare parts 4 and/or autonomous vehicles guided between the different facilities and/or entities to transport spare parts 4. The different facilities and/or entities may be spread across a country 21 or region as may be seen in FIG. 1.

To provide the respective information and/or criteria for managing the warehouse 2, any one, any combination, or all of the warehouse 2, the one or more agricultural machines 5 of the fleet 6, the one or more central storages 16, the one or more neighboring warehouses 17, the part runners 19, or the drones 20 may communicate with any one, any combination, or all of the server 7, the database 8, or the one or more user end devices 9 via the network 10 to provide the respective information and/or criteria 15 for managing the warehouse 2 to the database 8 for storing the same. There may be no need for direct communication between the respective facilities and/or entities and the database 8 to store the information and/or criteria 15. Rather, the information and/or criteria 15 may be delivered to the database 8 via the server 7 and/or via the one or more user end devices 9. Moreover, the information and/or criteria 15 for automatically managing the warehouse 2 may not necessarily be provided directly by the facilities and/or entities mentioned before. Rather, the information and/or criteria 15 may be provided by any one, any combination, or all of a user 22 of the warehouse 2, service providers, spare part dealers, manufacturers of spare parts 4, and/or agricultural machines 5 or the like coordinating a stocking and replenishing of the warehouse 2, for example via one or more user end devices 9. In other words, the user 22 of the warehouse 2, service providers, spare part dealers, manufacturers or the like may define at least some of the information and/or criteria 15 for managing the warehouse 2, such as via the at least one user end device 9.

The information and/or criteria 15 for automatically managing the warehouse 2 may comprise information regarding any one, any combination, or all of a geographic position of the warehouse 2, an actual stock of the warehouse 2, criteria regarding the stock of the warehouse 2 (e.g., any one, any combination, or all of: spare part type criteria, spare part amount criteria, time period criteria, replenishment cycle criteria, replenishment time criteria or the like), information regarding a configuration of the one or more agricultural machines 5 of the fleet 6, information regarding an operation of the one or more agricultural machines 5 of the fleet 6, information regarding crops harvested by the one or more agricultural machines 5 of the fleet 6, information regarding agronomic conditions at the geographical position of the warehouse 2 (e.g., any one, any combination, or all of: soil information, crop information, yield information, area information or the like), information regarding climatic conditions at the geographical position of the warehouse 2 (e.g., any one, any combination, or all of: humidity information, temperature information, solar radiation information, wind speed information or the like), information regarding a geographical position of the one or more central storages 16, information regarding an actual stock of the one or more central storages 16, information regarding a geographical position of the one or more neighboring warehouses 17, information regarding an actual stock of the one or more neighboring warehouse 17, information regarding a geographical position of the part runners 19, information regarding an availability of the part runners 19, information regarding a capacity of the part runners 19, information regarding a geographical position of the drones 20 to automatically transport, information regarding an availability of the drones 20 to automatically transport, or information regarding a capacity of the drones 20 to automatically transport.

The module 14 may be configured to generate a geographical map containing at least some of the information and/or criteria 15 for managing the warehouse 2. In one or some embodiments, the module is configured to generate the geographical map containing any one, any combination, or all of stock information of the warehouse 2, the one or more central storages 16, or the one or more neighboring farms 18. In this regard, in one or some embodiments, the user 22 may tap, click or otherwise interact with the geographic map in order to access the information contained therein and/or thereon. The geographical map may thus assist the user 22, service providers, spare part dealers, manufacturers or the like in interacting with the module 14 to automatically plan, automatically instruct and automatically coordinate different management functions, some of these functions being explained in more detail in the following.

To provide a holistic management approach for the warehouse 2, the module 14 may be configured to perform automatically different functions (e.g., respective operations). One of these functions may be the ability to automatically provide to the user 22 of the warehouse 2 a recommendation for a stock to be stocked in the warehouse 2. In other words, the module 14 may be configured to automatically determine a stock of spare parts 4 recommended to be stocked in the warehouse 2 to secure operation of the one or more agricultural machines 5 of the fleet 6 during a predetermined time period, which may be configurable by the user 22, for example in form of the time period criteria mentioned above. The predetermined time period in which operation of the one or more agricultural machines 5 is to be secured may be a harvest season/campaign or an entire calendar year covering a pre-harvest season, the harvest season/campaign and a post-harvest season. Other time periods are likewise contemplated.

As mentioned above, the user 22 may often pre-order many spare parts 4 for different parts of the agricultural machine 5 which might suffer from a failure during the harvest campaign/season. After the harvest season/campaign, the user 22 often finds that not all of the spare parts 4 pre-ordered have been used up. As spare parts 4 usually cannot be sent back to service providers, spare part dealers and/or manufacturers. Separately, some of these spare parts 4 cannot be used in a following harvest season/campaign due to an expiry date. In this way, the user 22 may invest a huge amount of money for spare parts that won't be used in the end. Therefore, the module 14 is not only automatically configured to determine a stock of spare parts 4 recommended to be stocked in the warehouse 2 to secure operation of the one or more agricultural machines 5 of the fleet 6. Rather, the module 14 is configured to automatically determine the stock of spare parts 4 recommended to be stocked in the warehouse 2 according to the objective that the spare parts 4 of this stock have been used up after the expiry of the time period, for example after the harvest season/campaign. Depending on the predetermined time period defined, there may be different recommendations for a package of spare parts 4 to stock, which may be used up after the expiry of the time period with rather high probability. To perform such a recommendation, the module 14 may automatically access the different information and/or criteria 15 for managing the warehouse 2 and may automatically estimate a probability that certain parts of the one or more agricultural machines 5 will experience a failure within the time period defined. For parts that will suffer from a failure with rather high probability (e.g., greater than or equal to a predefined probability), the module 14 may automatically include the respective spare parts 4 in the stock recommendation. In this regard, responsive to the module 14 automatically determining the probability of failure within the predetermined time period and automatically determining that the probability of failure is greater than or equal to the predefined probability, the module 14 may automatically include the respective spare part(s) 4 in the stock recommendation.

However, to provide the holistic approach for managing the warehouse 2, providing the user 22 with a recommendation for a specific package of spare parts 4 to stock in the warehouse 2 on the farm 3 is not the only aspect that may be taken into account as giving a recommendation may not lead to a reception of these spare parts 4. Therefore, the module 14 may be further configured to automatically instruct and automatically trigger an ordering of spare parts 4 for the warehouse 2, a stocking of the warehouse 2 with spare parts 4 and/or a replenishment of the warehouse 2 with spare parts 4. In turn, the module 14 may cause the automatic obtaining (e.g., via robot(s) automatically obtaining the spare parts 4 from a separate warehouse) and/or automatic transporting (e.g., automatic transporting via drone(s)). Performing these functions by the module 14 may be based on the recommended stock of spare parts 4. However, execution of these functions need not necessarily be linked to a previous recommendation for a stock of spare parts 4 given by the module 14. Rather, these functions may be automatically performed based on an individual request sent by the user 22 of the warehouse 2 or the like.

To provide the module 14 with further intelligence to manage the warehouse 2, it may be advantageous that the one or more user end devices 9 comprise a sensor arrangement 23 for automatic identification of spare parts 4 being placed in the warehouse 2 and/or being dispatched out of the warehouse 2. Alternatively or in addition, the warehouse 2 itself may comprise a sensor arrangement 23 for automatic identification of spare parts 4 being placed in the warehouse 2 and/or being dispatched out of the warehouse 2. Using the sensor arrangement(s) 23, it may be possible to provide the module 14 with the ability to automatically track movements of the spare parts 4. In particular, the module 14 may be configured to automatically track a receipt of spare parts 4 in the warehouse 2 and/or a dispatch of spare parts 4 out of the warehouse 2 based on the spare parts 4 identified using the sensor arrangement(s) 23. In one or some embodiments, the module 14 may not only be able to automatically track the receipt of spare parts 4 and/or the dispatch of spare parts 4 out of the warehouse 2, but also may be configured to automatically link spare parts 4 being placed in the warehouse 2 and/or being dispatched out of the warehouse 2 with the one or more agricultural machines 5 of the fleet 6. This configuration may provide the user 22, service providers, spare part dealers and/or manufacturers with an overview of the allocation of spare parts 4 to unique agricultural machines 5 and/or consumption of the spare parts 4 by unique agricultural machines 5.

Automatic identification of the spare parts 4 being placed in the warehouse 2 and/or being dispatched out of the warehouse 2 may be done in different ways. According to one embodiment, the spare parts 4 may comprise identification tags which may be automatically readable by the sensor arrangement(s) 23. Such identification tags may be RFID-tags, QR-codes, barcodes or the like. According to another embodiment, the sensor arrangement(s) 23 is configured to identify the spare parts 4 using image recognition. Image recognition may be based on classical object recognition methods or algorithms, such as a watershed transformation, an edge detection, histogram methods, eigenspace methods or the like. Alternatively, image recognition may be based on adaptive object recognition algorithms, for example those based on neural networks. The sensor arrangement(s) 23 may comprise a processing device which may enable automatic identification of the spare parts 4 regardless of the method used for identification. Regarding the configuration of such a processing device, reference is made to the processing device 11 of the server 7.

Briefly summarized, using the module 14, it may be possible to provide a holistic approach for managing a warehouse 2 on a farm 3 in which spare parts 4 for one or more agricultural machines 5 of a fleet 6 of agricultural machines 5 are at least partly automatically (or fully automatically) stocked. Efficient management may be performed by having the ability to automatically access different information and/or criteria 15 defining the ecosystem for operating the warehouse 2. A user 22, service provider, spare part dealer, manufacturer or the like may be able to obtain access to the module 14 and to interact with the module 14 by an end user device 9 in order to influence or affect the management process of the warehouse 2.

Regardless of the different functions executable by the module 14 for automatic managing of the warehouse 2, the use of the module 14 by the user 22 may be part of a service. The module 14 may be assigned to an entity, which may be independent of the user 22 of the warehouse 2, for example a service provider, a spare part dealer and/or a manufacturer of spare parts 4 and/or the agricultural machine 5. The access to use the module 14 by the user 22 of the warehouse 2 may be enabled by the entity responsive to an authorization is present. Authorization may be obtained, for example, by paying a fee to the entity (e.g., responsive to requesting access to the module 14, the user 22 may input authorization information, which may be compared with predetermined authorization information; responsive to the comparison, the user 22 may be provided access to the module 14). The module 14 may be configured to manage some or all monetary actions regarding the operation of the warehouse 2, such as for example, obtaining authorization to use the warehouse 2, booking spare part packages, canceling the authorization to use the warehouse 2 or the like.

The particular combinations of elements and features in the above detailed embodiments are exemplary only; the interchanging and substitution of these teachings with other teachings in this and the patents/applications incorporate by reference are also expressly contemplated. As those skilled in the art will recognize, variations, modifications, and other implementations of what is described herein may occur to those of ordinary skill in the art without departing from the spirit and the scope of the invention as claimed. Accordingly, the foregoing description is by the way of example only and is not intending as limiting. In the claims, the wording “comprising” does not exclude other elements or steps, and the identified article “a” or “an” does not exclude a plurality. The mere fact that certain measures are recited in mutually different dependent claims does not indicate that a combination of these measures cannot be used to advantage. The inventions scope is defined in the following claims and the equivalents thereto. Furthermore, reference signs used in the description and claims do not limit the scope of the invention as claimed.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 System for managing a warehouse
2 Warehouse
3 Farm
4 Spare part
5 Agricultural machine
6 Fleet
7 Server
8 Database
9 User end device
10 Network
11 Processing device
12 Processor
13 Memory
14 Module
15 Information and/or criteria for managing a warehouse
16 Central storage
17 Neighboring warehouse
18 Neighboring farm
19 Part runner
20 Drone
21 Country or region
22 User
23 Sensor arrangement

1. A system configured to manage a warehouse on a farm in which spare parts for at least one agricultural machine of a fleet of agricultural machines are stocked, the system comprising:
at least one server;
at least one database; and
at least one user end device;
wherein the at least one server, the at least one database, and the at least one user end device are configured to communicate with each other via one or more networks;
wherein at least one module is configured to use one or both of information or criteria for managing the warehouse and for storage in the at least one database;
wherein the at least one module is executable by the at least one user end device;
wherein the at least one server is configured to host the at least one module for the at least one user end device; and
wherein upon execution of the at least one module by the at least one user end device, the at least one module is configured to automatically manage a stock of spare parts in the warehouse based on the one or both of the information or the criteria stored in the database.

2. The system of claim 1, wherein the at least one module is configured to automatically determine the stock of spare parts recommended to be stocked in the warehouse to secure operation of the at least one agricultural machine during a predetermined time period.

3. The system of claim 2, wherein the at least one module is configured to automatically determine the stock of spare parts recommended to be stocked in the warehouse according to an objective that the spare parts have been used up after expiry of the predetermined time period.

4. The system of claim 1, wherein the at least one module is configured to automatically instruct and automatically trigger of an ordering of stocking or replenishment of the spare parts according to a recommended stock of spare parts determined; and
responsive to the automatically trigger the ordering, the one or more spare parts are at least partly automatically transported to the warehouse.

5. The system of claim 1, wherein one or both of the at least one user end device or the warehouse comprise a sensor arrangement configured to automatically identify the spare parts being one or both of placed in the warehouse or dispatched out of the warehouse.

6. The system of claim 5, wherein the at least one module is configured to automatically track one or both of a receipt of the spare parts in the warehouse or a dispatch of the spare parts out of the warehouse based on the automatically identifying the spare parts; and
wherein the at least one server is configured to control automatic dispatch of the spare parts out of the warehouse based on automatic control of one or more drones.

7. The system of claim 5, wherein the sensor arrangement is configured to automatically identify the spare parts by automatically reading identification tags on the spare parts or by image recognition.

8. The system of claim 5, wherein the at least one module is configured to automatically link the spare parts being one or both of placed in the warehouse or dispatched out of the warehouse with the at least one agricultural machine.

9. The system of claim 1, wherein one or both of the information or criteria for managing the warehouse are related to one or more of: the warehouse; the at least one agricultural machine; at least one central storage for the spare parts; at least one neighboring warehouse for the spare parts on a neighboring farm; part runners; or drones for automatic transportation of the spare parts between different facilities or entities.

10. The system of claim 9, wherein one or more of the warehouse on the farm, the at least one agricultural machine on the farm, the at least one central storage, the at least one neighboring warehouse, the part runners, or the drones automatically communicate with one or more of the at least one server, the at least one database, or the at least one user end device via the one or more networks to automatically provide the one or both of the information or criteria to the at least one database for storage in order to automatically manage the warehouse.

11. The system of claim 9, wherein one or both of the information or the criteria for managing the warehouse comprise one or more of the following:
information regarding a geographic position and/or an actual stock of the warehouse;
criteria regarding the stock of the warehouse;
information regarding a configuration of the at least one agricultural machine;
information regarding an operation of the at least one agricultural machine;
information regarding crops harvested by the at least one agricultural machine;
information regarding agronomic conditions at the geographical position of the warehouse;
information regarding climatic conditions at the geographical position of the warehouse;
information regarding a geographical position and/or an actual stock of the at least one central storage;
information regarding a geographical position and/or an actual stock of the at least one neighboring warehouse; or
information regarding a geographical position, an availability, or a capacity of one or both of the part runners or the drones.

12. The system of claim 11, wherein the at least one module is configured to generate a geographical map containing at least some of the one or both of the information or criteria for managing the warehouse including stock information of the warehouse, the at least one central storage, and at least one neighboring farm.

13. The system of claim 9, wherein one or both of the information or the criteria for managing the warehouse comprise each of the following:
information regarding a geographic position and/or an actual stock of the warehouse;
criteria regarding the stock of the warehouse;
information regarding a configuration of the at least one agricultural machine;
information regarding an operation of the at least one agricultural machine;
information regarding crops harvested by the at least one agricultural machine;
information regarding agronomic conditions at the geographical position of the warehouse;
information regarding climatic conditions at the geographical position of the warehouse;
information regarding a geographical position and/or an actual stock of the at least one central storage;
information regarding a geographical position and/or an actual stock of the at least one neighboring warehouse; and
information regarding a geographical position, an availability, or a capacity of one or both of the part runners or the drones.

14. The system of claim 1, wherein the at least one user end device of the warehouse, a service provider, a spare parts dealer, or a manufacturer of spare parts or the at least one agricultural machine is configured to receive input from a user in order to define at least some of the information or criteria for managing the warehouse.

15. The system of claim 1, wherein the at least one user end device is configured to interact with the at least one module via at least one application configured to execute on the at least one user end device.

16. The system of claim 1, wherein the at least one module is assigned to an entity which is independent of a user of the warehouse; and
wherein access to use the module by the user of the warehouse is enabled by the entity responsive to authorization being determined.

17. A method for managing a warehouse on a farm in which spare parts for at least one agricultural machine of a fleet of agricultural machines are stocked, the method comprises:
using a system comprising at least one server, at least one database, and at least one user end device, wherein the at least one server, the at least one database, and the at least one user end device are configured to communicate with each other via one or more networks;
executing, by the at least one user end device, at least one module that uses one or both of information or criteria for managing the warehouse and for storage in the at least one database;
hosting, by the at least one server, the at least one module for the at least one user end device; and
responsive to execution of the at least one module by the at least one user end device, the at least one module automatically manages a stock of spare parts in the warehouse based on the one or both of the information or the criteria stored in the database.

18. The method of claim 17, wherein the at least one module automatically determines the stock of spare parts recommended to be stocked in the warehouse to secure operation of the at least one agricultural machine during a predetermined time period.

19. The method of claim 18, wherein the at least one module automatically determines the stock of spare parts recommended to be stocked in the warehouse according to an objective that the spare parts have been used up after expiry of the predetermined time period.
